(19) United States
(12) Patent Application Publication
(10) Pub. No.: US 2007/0120534 A1
(43) Pub. Date: May 31, 2007

(54) Method of measuring intrinsic resistance of battery and apparatus of same

(76) Inventor: Youichi Arai, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/581,920

(22) PCT Filed: Jan. 20, 2005
(86) PCT No.: PCT/JP05/00679

§ 371 Date: Jun. 7, 2006

(30) Foreign Application Priority Data
Jan. 21, 2004 (JP) 2004-013363

(51) Int. Cl. H02J 7/00

(52) U.S. Cl. 320/133

(57) ABSTRACT

The present invention provides a method of measuring an intrinsic resistance of a battery at a low rate discharge and an apparatus of the same. A method of measuring an intrinsic resistance of a battery includes the steps of: measuring periodically a discharge current and a terminal voltage responding to the discharge current at a low rate discharge of the battery; determining a first approximate expression of the terminal voltage with respect to the increasing discharge current and a second approximate expression of the terminal voltage with respect to the decreasing discharge current based on the measured discharge current and terminal voltage; defining a range of the intrinsic resistance based on the first and second approximate expressions; assuming a resistance in the range of the intrinsic resistance as a tentative intrinsic resistance; determining a tentative maximum polarization time from the second approximate expression and the tentative intrinsic resistance; and determining the intrinsic resistance from two relational expressions including the intrinsic resistance, an intrinsic maximum polarization time and the tentative maximum polarization time.

### TECHNICAL FIELD

The present invention relates to a method of measuring an intrinsic resistance of a battery which supplies electric power to loads of a vehicle, and an apparatus of the same.

### RELATED ART

When an engine of a vehicle is started with a starter, an inrush current flows through the starter. The inrush current has a very high current with a short period of time compared with a steady current.

The short period of time means that a polarization can be well correlated with a discharge current. The high current means that the polarization can be reliably determined with accuracy of voltage and current. In the case of a lead battery, the short period of time means at most 400 msec and the inrush current is at least 3 C.

JP,2003-115331,A discloses a method of measuring an intrinsic resistance of a battery at a high rate discharge of the inrush current.

The method is explained by referring to FIGS. 6 and 7. As shown in FIG. 6A, when a high rate discharge starts, a concentration polarization increases until a discharge current reaches to a peak current Iₚ. When the discharge current starts to decrease, the concentration polarization can not decrease concurrently due to late response. Accordingly, the concentration polarization continues to increase for a while and decrease. In the case of the high rate discharge with a short period of time, the concentration polarization becomes a maximum value at a time when the high rate discharge is terminated.

High-rate sampling of the discharge current and a terminal voltage provides I-V characteristics as shown in FIG. 7. A difference e₀ of the terminal voltage between the start and end of the discharge is the maximum value of the concentration polarization. The concentration polarization at the peak current Iₚ is determined by utilizing the maximum concentration polarization e₀. The determined concentration polarization is subtracted from the I-V characteristic of the discharge current and terminal voltage so that I(the discharge current)-V(a voltage drop of the battery due to the intrinsic resistance and activation polarization) characteristic is determined. The intrinsic resistance is determined from the voltage drop characteristic by utilizing a difference of characteristics between the activation polarization and the intrinsic resistance.

The above method can determine the intrinsic resistance every time when the high rate discharge is generated.

Under a circumstance of use of a battery, there is a case that a high rate discharge does not occur. A measurement of an intrinsic resistance at a low rate discharge, a current of at least 3 C, is requested.

The low rate discharge of the current of 1 C-3 C induces a concentration polarization smaller than the case of the high rate discharge and then the concentration polarization disappears faster when the discharge current decreases. Accordingly, as shown in FIG. 6B, the concentration polarization does not show the maximum at the termination of the discharge in contrast to the high rate discharge.

Then, the measurement of the intrinsic resistance of the battery at the low rate discharge as described in JP,2003-115331,A does not give high measurement accuracy.

### DISCLOSURE OF THE INVENTION

The present invention is to provide a method of measuring an intrinsic resistance of a battery at a low rate discharge and an apparatus of the same.

According to a first aspect of the present invention, a method of measuring an intrinsic resistance of a battery includes the steps of: measuring periodically a discharge current and a terminal voltage responding to the discharge current at a low rate discharge of the battery; determining a first approximate expression of the terminal voltage with respect to the increasing discharge current and a second approximate expression of the terminal voltage with respect to the decreasing discharge current based on the measured discharge current and terminal voltage; defining a range of the intrinsic resistance based on the first and second approximate expressions; assuming a resistance in the range of the intrinsic resistance as a tentative intrinsic resistance; determining a tentative maximum polarization time from the second approximate expression and the tentative intrinsic resistance; and determining the intrinsic resistance from two relational expressions including the intrinsic resistance, an intrinsic maximum polarization time and the tentative maximum polarization time.

The method of measuring the intrinsic resistance of the battery includes the steps of: measuring periodically the discharge current and the terminal voltage responding to the discharge current at the low rate discharge of the battery; determining the first approximate expression of the terminal voltage with respect to the increasing discharge current and the second approximate expression of the terminal voltage with respect to the decreasing discharge current based on the measured discharge current and terminal voltage; defining the range of the intrinsic resistance based on the first and second approximate expressions; assuming the resistance in the range of the intrinsic resistance as the tentative intrinsic resistance; determining the tentative maximum polarization time from the second approximate expression and the tentative intrinsic resistance; determining the intrinsic resistance from two relational expressions including the intrinsic resistance, the intrinsic maximum polarization time and the tentative maximum polarization time; and solving simultaneous equations of the two relational expressions to obtain the intrinsic resistance.

The two relational expressions comprise: a first relational expression given by equating the intrinsic resistance to a formula of {(a period of time between a start of discharge and the intrinsic maximum polarization time)/(a period of time between the start of discharge and the tentative maximum polarization time)}×(a maximum value in the range of the intrinsic resistance)+{(a period of time between the intrinsic maximum polarization time and the tentative maximum polarization time)/(the period of time between the start of discharge and the tentative maximum polarization time)}×(a minimum value in the range of the intrinsic resistance); and a second relational expression given by equating the intrinsic resistance to a formula of a differential equation of the second approximate expression substituted the discharge current with a current of a formula of (a peak current)×{(the period of time between the intrinsic and tentative maximum polarization times)/(a period of time between a peak current time and the tentative maximum polarization time).

The two relational expressions comprise: the first relational expression given by equating the intrinsic resistance to the formula of {(the period of time between the start of discharge and the intrinsic maximum polarization time)/(the period of time between the start of discharge and the tentative maximum polarization time)}×(the maximum value in the range of the intrinsic resistance)+{(the period of time between the intrinsic maximum polarization time and the tentative maximum polarization time)/(the period of time between the start of discharge and the tentative maximum polarization time)}×(the minimum value in the range of the intrinsic resistance); and the second relational expression given by equating the intrinsic resistance to the formula of the differential equation of the second approximate expression substituted the discharge current with the current of the formula of (the peak current)×{(the period of time between the intrinsic and tentative maximum polarization times)/(the period of time between the peak current time and the tentative maximum polarization time). Accordingly, the intrinsic resistance is accurately obtained.

The method further includes the steps of: differentiating the first approximate expression with respect to the discharge current to obtain a first amount of change; differentiating the second approximate expression with respect to the discharge current to obtain a second amount of change; and defining the range of the intrinsic resistance between (the first amount of change+the second amount of change)/2 and (the second amount of change) at the peak current.

Accordingly, the range of the intrinsic resistance is further defined.

Preferably, the center value of the range of the intrinsic resistance is the tentative intrinsic resistance.

Accordingly, the difference between the intrinsic resistance and tentative intrinsic resistance becomes small.

An apparatus for measuring an intrinsic resistance of a battery includes: a current sensor for measuring a discharge current of a battery at a low rate discharge; a voltage sensor for measuring a terminal voltage of the battery responding to the discharge current; an interface circuit for converting the measured voltage from analog to digital; and a microcomputer having a CPU, a RAM and a ROM, wherein the CPU receives data of the measured current and voltage from the interface circuit; calculates a first approximate expression of the terminal voltage with respect to the increasing discharge current and a second approximate expression of the terminal voltage with respect to the decreasing discharge current from the measured discharge current and terminal voltage; defines a range of the intrinsic resistance from the first and second approximate expressions; assumes a resistance in the range of the intrinsic resistance as a tentative intrinsic resistance; determines a tentative maximum polarization time from the second expression and the tentative intrinsic resistance; and determines the intrinsic resistance from two relational expressions including the intrinsic resistance, an intrinsic maximum polarization time and the tentative maximum polarization time.

The apparatus for measuring the intrinsic resistance of the battery includes: the current sensor for measuring the discharge current of the battery at the low rate discharge; the voltage sensor for measuring the terminal voltage of the battery responding to the discharge current; the interface circuit for converting the measured voltage from analog to digital; and the microcomputer having the CPU, RAM and ROM, wherein the CPU receives data of the measured current and voltage from the interface circuit; calculates the first approximate expression of the terminal voltage with respect to the increasing discharge current and the second approximate expression of the terminal voltage with respect to the decreasing discharge current from the measured discharge current and terminal voltage; defines the range of the intrinsic resistance from the first and second approximate expressions; assumes the resistance in the range of the intrinsic resistance as the tentative intrinsic resistance; determines the tentative maximum polarization time from the second expression and the tentative intrinsic resistance; determines the intrinsic resistance from two relational expressions including the intrinsic resistance, the intrinsic maximum polarization time and the tentative maximum polarization time; and solves the two simultaneous relational expressions to obtain the intrinsic resistance.

### BRIEF DESCRIPTION OF THE DRAWINGS

FIG. 1 is a block diagram of a configuration of an in-vehicle unit for measuring an intrinsic resistance of a battery of the present invention;

FIG. 2 is a flowchart showing a processing order of a CPU 23a of the in-vehicle unit of FIG. 1;

FIG. 3 shows a current increasing curve L₁ and current decreasing curve L₂ at a low rate discharge;

FIG. 4 shows a relation between tangential angles α, β and a tentative intrinsic resistance Rₜ;

FIG. 5 shows polarization curves L₅ and L₆ for the tentative and intrinsic resistances Rₜ and R, respectively, of Vₚ−t characteristic, where Vₚ is polarization and t is a discharge time;

FIG. 6A is Vₚₒₗ(concentration polarization)−t(discharge time) characteristic at a high rate discharge;

FIG. 6B is Vₚₒₗ−t characteristic at the low rate discharge; and

FIG. 7 is I(discharge current)−V(terminal voltage) characteristic at the high rate discharge.

### BEST MODE FOR CARRYING OUT THE INVENTION

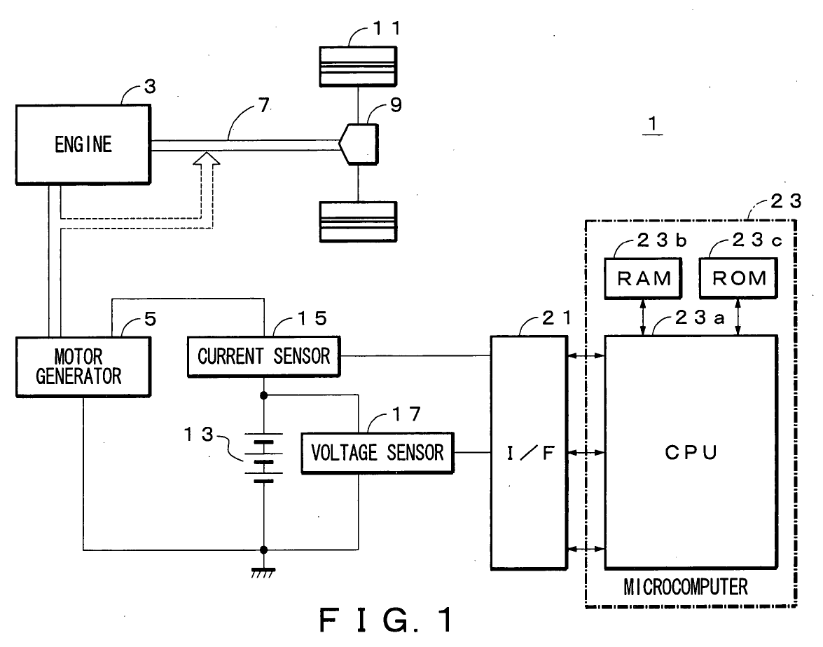

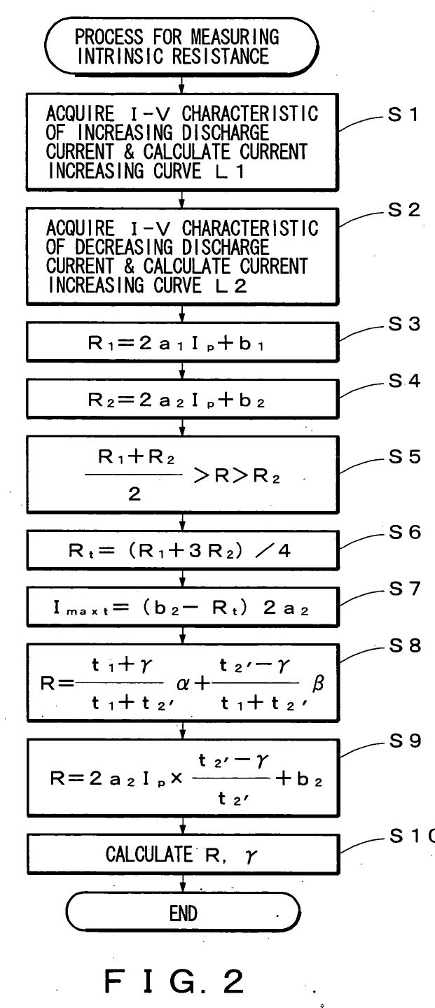

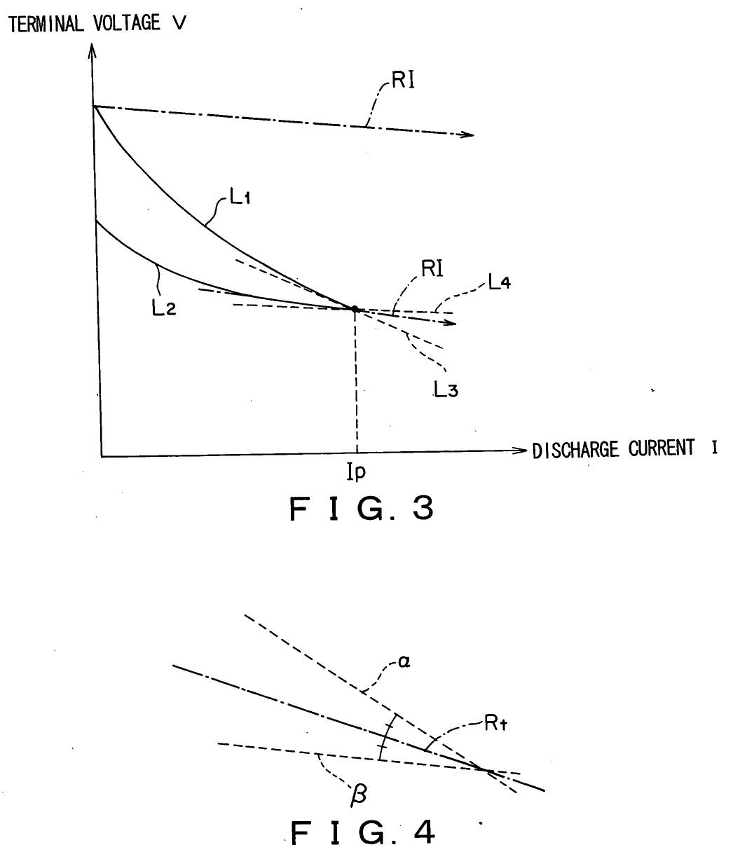

FIGS. 1 and 2 show an apparatus of measuring an intrinsic resistance of a battery of the present invention. A method of the measurement is explained by referring to FIGS. 3-5.

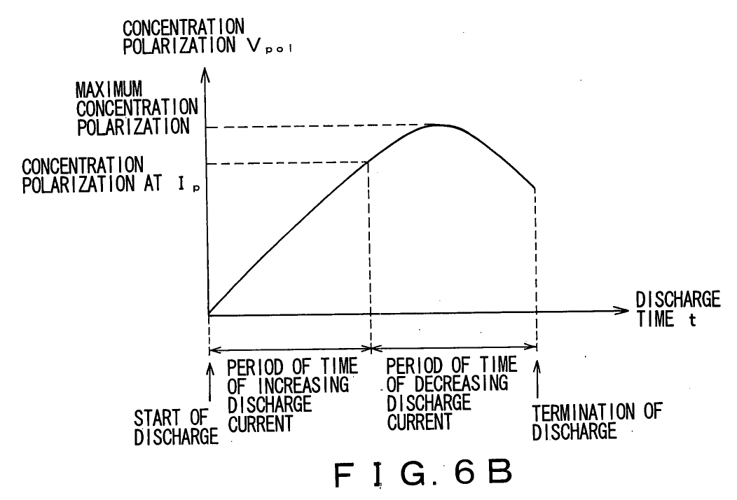

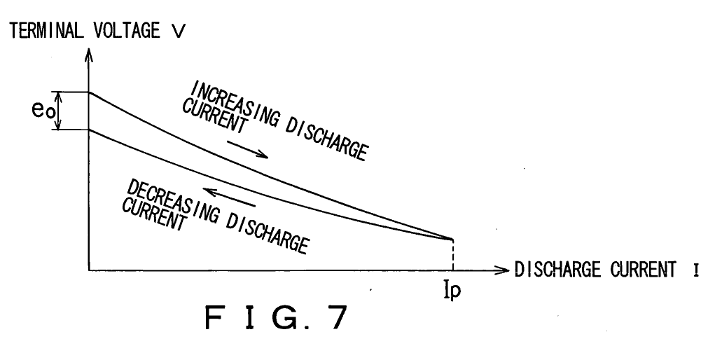

A low rate discharge discharges a low discharge current (about 1 C-3 C) for a short period of time for a hour rate capacity of the battery. At the low rate discharge, the discharge current increases monotonically from zero to a peak value and decreases in a short period of time and reaches to a steady value corresponding to a load. In the low rate discharge, a concentration polarization reaches to a maximum value prior to the termination of the discharge as shown in FIG. 6B.

The discharge current and terminal voltage of the battery are measured every a certain period of time at the low rate discharge with increasing and decreasing discharge currents. The measured pairs of the discharge currents I and terminal voltages V are fitted into quadratic approximate expressions of
V=a₁I²+b₁I+c₁ (a current increasing curve) Eq. 1
and
V=a₂I²+b₂I+c₂ (a current decreasing curve) Eq. 2.
Eqs. 1 and 2 are denoted as a first approximate expression and second approximate expression, respectively. In FIG. 3, L1 and L2 show the current increasing and decreasing curves, respectively.

Eqs. 1 and 2 are differentiated and a peak current Iₚ is substituted in the differentiated equations to obtain a change of the terminal voltage per unit discharge current at Iₚ and a change of an internal resistance (=intrinsic resistance+concentration polarization resistance+activation polarization resistance) at Iₚ. The change of resistance at the increasing and decreasing currents are expressed with
R₁=2a₁Iₚ+b₁ Eq. (3)
and
R₂=2a₂Iₚ+b₂ Eq. (4)
respectively. The R₁ and R₂ are denoted as a first amount of change and a second amount of change at the peak current Iₚ, respectively.

The R₁ and R₂ are angles of tangential lines L₃ and L₄ of the first and second approximate expressions L₁ and L₂ at the peak current Iₚ. The relation between R₁, R₂ and the intrinsic resistance R is explained.

The intrinsic resistance R is not related with chemical reactions and is constant unless the state of charge (SOC) and the temperature of the battery change. Then, the intrinsic resistance R is assumed to be constant at the low rate discharge so that the voltage drop RI due to the intrinsic resistance R is expressed by a dash-dotted line RI of FIG. 3.

The polarization (activation+concentration) increases with increase of the discharge current I and then the current increasing curve L₁ deviates downwardly from the voltage drop RI. Then, the angle R₁ of the tangential line L₃ at Iₚ of the curve L₁ is larger than the slope of RI, that is R₁>R.

The response of the above polarization is slow so that it still increases for a while and then decreases with decrease of the discharge current I. Accordingly, the current decreasing curve L₂ further deviates from the voltage drop RI and approaches to the potential drop RI.

The current decreasing curve L₂ departs further from the voltage drop RI so that the angle R₂ of the tangential line L₄ of the current decreasing curve L₂ at the peak current Iₚ is smaller than that of the voltage drop RI, that means R₂<R.

As shown in FIG. 6B, at the low rate discharge, the polarization increases after the discharge current decreases but the increasing amount is small compared with the amount that the increasing discharge current generates. Hence, the difference of the angle of the tangential lines between R₁−R is larger than that between R−R₂, namely R₁−R>R−R₂. Then, a range of the intrinsic resistance is defined by
{(R₁+R₂)/2}>R>R₂ Eq. 5.
Hereafter, it is denoted (R₁+R₂)/2=α, R₂=β.

The intrinsic resistance R can also be in the range of R₁>R>R₂. The narrower range of the intrinsic resistance R of Eq. 5 provides a more accurate value.

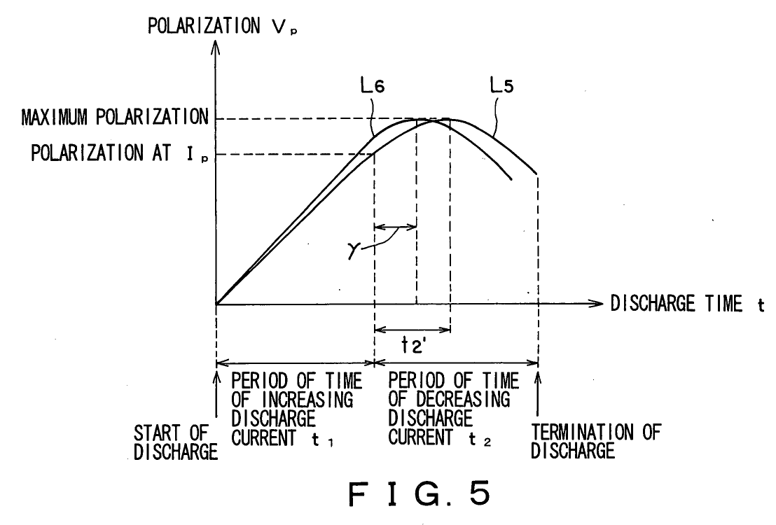

Suppose that the intrinsic resistance R is the center value of α and β, the value (a tentative intrinsic resistance) becomes
Rₜ=(α+β)/2=(R₁+3R₂)/4 Eq. 6.
As shown in FIG. 4, the tentative intrinsic resistance Rₜ is in the middle value of the angles of α and β.

The tentative intrinsic resistance Rₜ may not be in the center between α and β. It is assumed that the center value provides a more accurate intrinsic resistance of the battery.

The polarization shows the maximum value when the discharge current decreases. The subtraction of the voltage drop RₜI of the tentative intrinsic resistance Rₜ from the current decreasing curve L₂ gives a voltage drop Vₚ originating from only the polarization as given by
Vₚ=(a₂I²+b₂I+c₂)−RₜI=a₂I²+{b₂−(R₁+3R₂)/4}I+c₂ Eq. 7.

Differentiating Eq. 7 with the discharge current I becomes the equation,
dVₚ/dI=2a₂I+{b₂−(R₁+3R₂)/4}.
Equating the differential equation to zero gives a tentative discharge current Iₘₐₓₜ at which the polarization of the internal resistance excluding the tentative intrinsic resistance Rₜ becomes the maximum value. The equations are given by
2a₂Iₘₐₓₜ+{b₂−(R₁+3R₂)/4}=0
and
Iₘₐₓₜ={b₂−(R₁+3R₂)/4}/2a₂ Eq. 8.

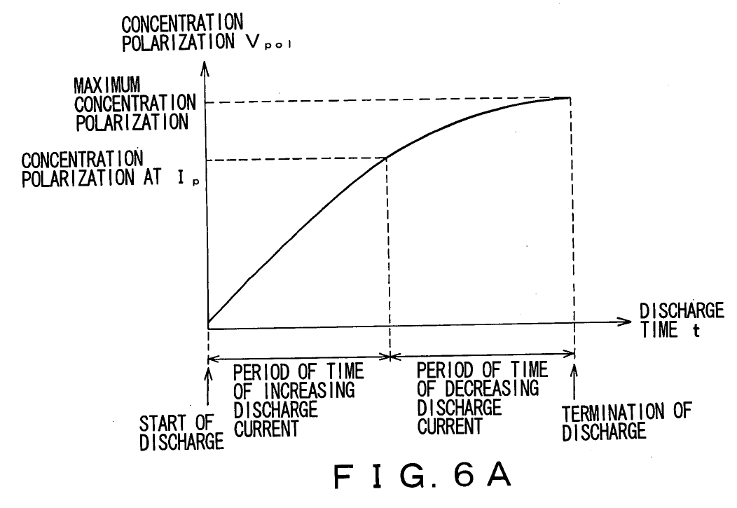

A relation between a discharge time t and the intrinsic resistance Rₜ is explained below. FIG. 5 is a graph of the discharge time t and the polarization Vₚ at the low rate discharge. In FIG. 5, t₁ denotes a period of time between the start and the peak current Iₚ of the discharge current and t₂ denotes a period of time between the peak current Iₚ and the termination of the discharge current.

A polarization curve L₅ shows a relation between the polarization Vₚ and the discharge current t for the tentative intrinsic resistance Rₜ and the polarization curve L₆ shows a relation between the polarization Vₚ and the discharge time t for the intrinsic resistance R.

In FIG. 5, t_{2′} denotes a period of time between the peak current Iₚ and the tentative maximum polarization time of the tentative intrinsic resistance R of the discharge time t. The t_{2′} is determined from the measured pair of data and Iₘₐₓₜ of Eq. 8. A γ denotes a period of time between the peak current Iₚ and an intrinsic maximum polarization time of the discharge time.

The intrinsic resistance R approaches to a as (t₁+γ) further occupies the period of time (t₁+t_{2′}) and approaches to β as (t_{2′}−γ) further occupies the period of time (t₁+t_{2′}). The intrinsic resistance R is given by
R={(t₁+γ)/(t₁+t_{2′})}α+{(t_{2′}−γ)/(t₁+t_{2′})}β Eq. 9.
Eq. 9 is referred to a first relational expression.

The change of the current decreasing curve with respect to the discharge current is given by the equation
dV/dI=2a₂I+b₂ Eq. 10.
The change of the polarization becomes zero at the maximum polarization and the change of the current decreasing curve L₂ becomes equal to the intrinsic resistance R. When Iₘₐₓ is assumed to be a current having the maximum polarization and is substituted in Eq. 10, the result gives the intrinsic resistance R as a formula
2a₂Iₘₐₓ+b₂=R.

The Iₘₐₓ approaches to Iₚ as the time γ becomes small in the period of the time t_{2′}. Then Iₘₐₓ is given by
Iₘₐₓ=Iₚ(t_{2′}−γ)/t_{2′} Eq. 11.
Substitution of Eq. 11 to the formula 2a₂Iₘₐₓ+b₂=R gives a formula
R=2a₂Iₚ{(t_{2′}−γ)/t_{2′}}+b₂ Eq. 12.
Eq. 12 is referred to a second relational expression.

Unknowns in Eqs. 9 and 12 are the intrinsic resistance R and γ. Then, the solutions of the simultaneous Eqs. 9 and 12 give the value of R and γ. Accordingly, the intrinsic resistance is obtained even at the low rate discharge.

The intrinsic resistance of the battery is measured with a configuration schematically shown in FIG. 1.

FIG. 1 shows a block diagram of the configuration of an in-vehicle unit 1 for the intrinsic resistance measurement of the battery of the present invention. The in-vehicle unit 1 is mounted to a hybrid vehicle having an engine 3 and a motor generator 5.

In the hybrid vehicle, wheels 11 are driven by the engine 3 through a drive shaft 7 and a differential case 9 at a normal operation. At a high load operation, the motor generator 5 functions as a motor, which is power supplied with a battery 13, and assists to the drive shaft 7 connected to the differential case 9 and wheels 11.

The motor generator 5 functions as a generator when the hybrid vehicle decelerates or is braked so as to charge the battery 13 by transforming kinetic energy to electric energy.

The in-vehicle unit 1 of the embodiment of the present invention includes a current sensor 15 for detecting a discharge current I of the battery 13 and a voltage sensor 17 having an infinite resistance and connected in parallel with the battery 13 for detecting a terminal voltage V of the battery 13.

The in-vehicle unit 1 includes a interface circuit 21, hereafter denoted as I/F, for A/D transformation and a microcomputer 23. The outputs of the current and voltage sensors 15, 17 are input to the microcomputer 23 through the I/F 21.

The microcomputer 23 has a central processing unit (CPU) 23a for processing programs, a ROM 23c for storing the programs processed by the CPU 23a, and a RAM 23b having a working area for processing the programs with the CPU 23a and a storing area for storing several data.

FIG. 2 shows a flowchart of processing the programs with the CPU 23a for the above described in-vehicle unit 1. When the battery 13 starts a low rate discharge, the discharge current I and the terminal voltage V are measured with the current sensor 15 and the voltage sensor 17 and the CPU 23a receives the pair of the current-voltage data for calculating the intrinsic resistance of the battery 13. At step S1, the I-V characteristic with increase of the discharge current is obtained and a quadratic approximate expression of the current increasing curve L₁ of Eq. 1 is determined with least-square method.

At step S2, the CPU 23a receives the I-V data when the current decreases and determines a quadratic approximate expression of the current decreasing curve L₂ of Eq. 2 with least-square method. The current sensor 15, voltage sensor 17 and CPU 23a form a measuring means. The CPU 23a calculates the approximate expressions.

At steps S3 and S4, the CPU 23a determines the tangential angles R₁(=2a₁Iₚ+b₁, Eq. 3) and R₂(=2a₂Iₚ+b₂, Eq. 4) of the current increasing and decreasing curves L₁ and L₂ at the peak current Iₚ.

At step S5, the CPU 23a determines the range of the intrinsic resistance R, [{(R₁+R₂)/2}>R>R₂], from the values of R₁ and R₂. At step S6, the CPU 23a determines the center value in the range of the intrinsic resistance as a tentative intrinsic resistance Rₜ=(R₁+3R₂)/4. At step S7, the CPU 23a assumes the tentative intrinsic resistance Rₜ as the intrinsic resistance R and determines a tentative discharge current Iₘₐₓₜ of the tentative maximum polarization time.

At steps S8, S9 and S10, the CPU 23a determines the unknown γ and the intrinsic resistance R by solving the simultaneous Eqs. 9 and 12. Accordingly, the CPU 23a has means for determining the intrinsic resistance.

Solving the simultaneous Eqs. 9 and 12 determines the intrinsic resistance of the battery at the low rate discharge in which the maximum polarization is not clearly known.

### INDUSTRIAL APPLICABILITY

According to the inventions of claims 1 and 5, a first and second relational expressions, which include unknowns of an intrinsic resistance and intrinsic maximum polarization time and a known of a tentative maximum polarization time, are solved to obtain the intrinsic resistance. The present invention provides a method of measuring the intrinsic resistance of a battery at a low rate discharge which does not clearly define a maximum polarization time, and an apparatus of the same.

According to the invention of claim 2, the method provides accurately the intrinsic resistance from the first and second relational expressions.

According to the invention of claim 3, the method defines the range of the intrinsic resistance so that the intrinsic resistance of the battery is determined accurately.

According to the invention of claim 4, the method defines the center value of the range of the intrinsic resistance as the tentative intrinsic resistance to minimize a difference between the intrinsic and tentative resistances so that the intrinsic resistance of the battery is determined accurately.

1. A method of measuring an intrinsic resistance of a battery comprising the steps of:
measuring periodically a discharge current and a terminal voltage responding to the discharge current at a low rate discharge of the battery;
determining a first approximate expression of the terminal voltage with respect to the increasing discharge current and a second approximate expression of the terminal voltage with respect to the decreasing discharge current based on the measured discharge current and terminal voltage;
defining a range of the intrinsic resistance based on the first and second approximate expressions;
assuming a resistance in the range of the intrinsic resistance as a tentative intrinsic resistance;
determining a tentative maximum polarization time from the second approximate expression and the tentative intrinsic resistance; and
determining the intrinsic resistance from two relational expressions including the intrinsic resistance, an intrinsic maximum polarization time and the tentative maximum polarization time.

2. The method as claimed in claim 1, wherein said two relational expressions comprise:
a first relational expression given by equating the intrinsic resistance to a formula of {(a period of time between a start of discharge and the intrinsic maximum polarization time)/(a period of time between the start of discharge and the tentative maximum polarization time)}×(a maximum value in the range of the intrinsic resistance)+{(a period of time between the intrinsic maximum polarization time and the tentative maximum polarization time)/(the period of time between the start of discharge and the tentative maximum polarization time)}×(a minimum value in the range of the intrinsic resistance); and
a second relational expression given by equating the intrinsic resistance to a formula of a differential equation of the second approximate expression substituted the discharge current with a current of a formula of (a peak current)×{(the period of time between the intrinsic and tentative maximum polarization times)/(a period of time between a peak current time and the tentative maximum polarization time).

3. The method as claimed in claim 2, further comprising the steps of:
differentiating the first approximate expression with respect to the discharge current to obtain a first amount of change;
differentiating the second approximate expression with respect to the discharge current to obtain a second amount of change; and
defining the range of the intrinsic resistance between (the first amount of change+the second amount of change)/2 and (the second amount of change) at the peak current.

4. The method as claimed in claim 1, wherein the center value of the range of the intrinsic resistance is the tentative intrinsic resistance.

5. An apparatus for measuring an intrinsic resistance of a battery comprising:
a current sensor for measuring a discharge current of a battery at a low rate discharge;
a voltage sensor for measuring a terminal voltage of the battery responding to the discharge current;
an interface circuit for converting the measured voltage from analog to digital; and
a microcomputer having a CPU, a RAM and a ROM,
wherein the CPU
receives data of the measured current and voltage from the interface circuit;
calculates a first approximate expression of the terminal voltage with respect to the increasing discharge current and a second approximate expression of the terminal voltage with respect to the decreasing discharge current from the measured discharge current and terminal voltage;
defines a range of the intrinsic resistance from the first and second approximate expressions;
assumes a resistance in the range of the intrinsic resistance as a tentative intrinsic resistance;
determines a tentative maximum polarization time from the second expression and the tentative intrinsic resistance; and
determines the intrinsic resistance from two relational expressions including the intrinsic resistance, an intrinsic maximum polarization time and the tentative maximum polarization time.
